(19) United States
(12) Patent Application Publication
(10) Pub. No.: US 2015/0222738 A1
(43) Pub. Date: Aug. 6, 2015

(54) SYSTEM AND METHOD FOR PERSONAL COMMUNICATIONS AND PROTECTION USING INTELLIGENT ELECTRONICS

(71) Applicant: CUFF, Inc., Burlingame, CA (US)

(72) Inventors: Deepa Vora Sood, Berkeley, CA (US); Bradley Leong, Atherton, CA (US)

(21) Appl. No.: 14/611,928

(22) Filed: Feb. 2, 2015

Related U.S. Application Data
(60) Provisional application No. 61/934,690, filed on Jan. 31, 2014.

(51) Int. Cl. H04M 1/21

(52) U.S. Cl. CPC H04M 1/21

(57) ABSTRACT

A system and method for connecting and protecting people using a combination of (a) a “Private Personal Network” including a set of people who are defined as an individual's closest connections; (b) software that runs on mobile devices that manages, among other things, the members of the Private Personal Network, an individual's information, the connections to the Intelligent Electronics, and the connections to a cloud-based system; (c) a cloud based system that maintains connections among individuals, geographic data, and other data transmitted from the software on the mobile device, from the Intelligent Electronics, and from other sources; and (d) technology that receives and sends communication to the mobile device and is integrated with custom-designed wearable product.

### CROSS-REFERENCE AND RELATED APPLICATION

This application claims priority under 35 USC 119(e) to U.S. Provisional Application Ser. No. 61/934,690, filed on Jan. 31, 2014, titled SYSTEM AND METHOD FOR PERSONAL COMMUNICATIONS AND PROTECTION USING JEWELRY WITH BI-DIRECTIONAL INTERCHANGEABLE INTELLIGENT ELECTRONICS, the entire disclosures of which are incorporated herein by reference.

### BACKGROUND

The invention pertains generally to communication devices and, more specifically, to communication via an interchangeable electronic device that uses wireless protocols.

Existing communication devices, which are incorporated into wearable products, do not meet the demands and needs of the current consumer. For example, wearable products incorporate electronic components and sensors into plastic or molded bracelets and other such devices, which can be attached to the body through various mechanisms. However, most of these devices are not integrated into high end wearable products. Known approaches are segmented into three areas: wearable BLE devices, personal protective systems, and customizable jewelry.

With respect to wearable BLE devices, there are numerous devices (such as FitBit, Shine, and Fuel) that provide electronics integrated with molded plastic or metal. There are many disadvantages to these devices. For example, some of these devices require recharging on a regular basis, which may result in the device being unavailable when most needed. Furthermore, the decision to use molded plastic or metal means the aesthetics are appropriate primarily in sports situations and are not suitable to many social, work, or evening situations, severely limiting the utility of the device. Additionally, if the device is rechargeable, then it is both bulky and typically not waterproof, further limiting their usability by a wide range of physical body types and situations.

With respect to personal protective systems, there are numerous devices provided by LifeAlert (tethered to home) and Life360 (phone based only). Similarly these devices suffer from the same limitations.

With respect to devices that are part of customizable jewelry, there are similar limitations to using these products by fashion designers. For example, vendors such as Gucci or others only offer watches that have interchangeable rings providing color customization. These items serve no useful function and lack the intelligence needed to communicate information; they are only decorative.

In view of the foregoing disadvantages inherent in all the above types of products, all of which address part of a solution, but not the entirety of the needs of current consumers, an enhanced apparatus or device is needed along with a system that supports the data management. Therefore, what is needed is a system and method for integrating an electronic device into wearable products, such as jewelry, clothing, and handbags, to allow for communication and providing services to a consumer while maintaining a level of fashionable quality that is applicable under numerous settings.

### SUMMARY OF INVENTION

The present disclosure is directed at a system and method for integrating an electronic device into wearable products, such as jewelry, clothing, and handbags, to create intelligent products that provide many advantages. The disclosed aspects of the invention, as set out in the various embodiments, allow for communication to/from the device—from/to another device—while maintaining a level of fashionable quality that is applicable under numerous settings.

The various aspects of this disclosure can be implemented in any manner and the scope of the invention is not limited to specific embodiments disclosed. The device is able to communicate with a mobile device or directly to other intelligent jewelry. For example, the device can be integrated or secured to personal items such as jewelry to create intelligent jewelry. The intelligent jewelry serving either as originators of communications via a button-press, or receivers of information through the use of a coin vibrator or other alerting device that is an integrated component of the electronic device. The intelligent jewelry connects to and communicates through a mobile device or alternatively a “BLE concentrator” which serves as an intermediary communication and transmission hub, said intelligent jewelry additionally communicating via these means with a cloud application that manages people, connections, and locations.

In accordance with at least one aspect and embodiment disclosed herein, a system is disclosed that includes electronics that can be interchangeably embedded in jewelry. The jewelry can come in a variety of materials including leather, horn, metal, plastic, molded plastic, or other materials, referred to as an intelligent wearable product (IWP). The IWP is available in a variety of form factors, including but not limited to, bracelets, pendants, lavolieres, necklaces, cuff-links, earrings, ankle bracelets, key chains, belts, money clips, and other such jewelry items. The IWP, meant to be worn by people, communicates via software on a mobile device or other long-distance transmission device to a cloud system which facilitates communications and data management.

### BRIEF DESCRIPTION OF THE DRAWINGS

FIG. 1 shows a flow process for communication with an IWP, such as a registered device, in accordance with the various aspects of the present disclosure.

FIG. 2 shows a flow process for communication between the IWP and a mobile device in accordance with the various aspects of the present disclosure.

FIG. 3 is a block diagram of the registered device and various communication channels in accordance with the various aspects of the present disclosure.

FIG. 4A is a top view of an IWP, as shown in FIG. 3 in accordance with the various aspects of the present disclosure.

FIG. 4B is a perspective view of an IWP, as shown in FIG. 3 in accordance with the various aspects of the present disclosure.

FIG. 4C shows an IWP in accordance with the various aspects of the present disclosure.

FIG. 4D shows an IWP in accordance with the various aspects of the present disclosure.

FIG. 4E shows an IWP in accordance with the various aspects of the present disclosure.

FIG. 4F shows an IWP in accordance with the various aspects of the present disclosure.

FIG. 5 shows a system that includes the IWP in accordance with the various aspects of the present disclosure.

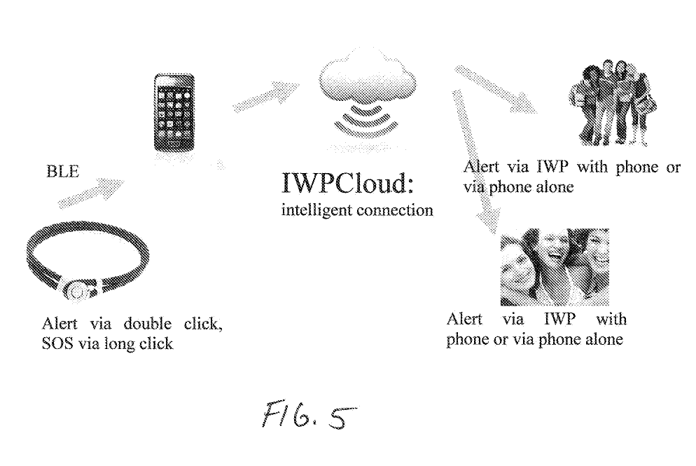

FIG. 6 shows various housing for the IWP in accordance with the various aspects of the present disclosure.

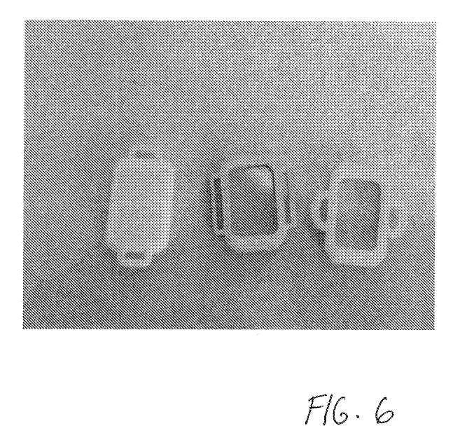

FIG. 7 shows various implementation of the IWP in accordance with the various aspects of the present disclosure.

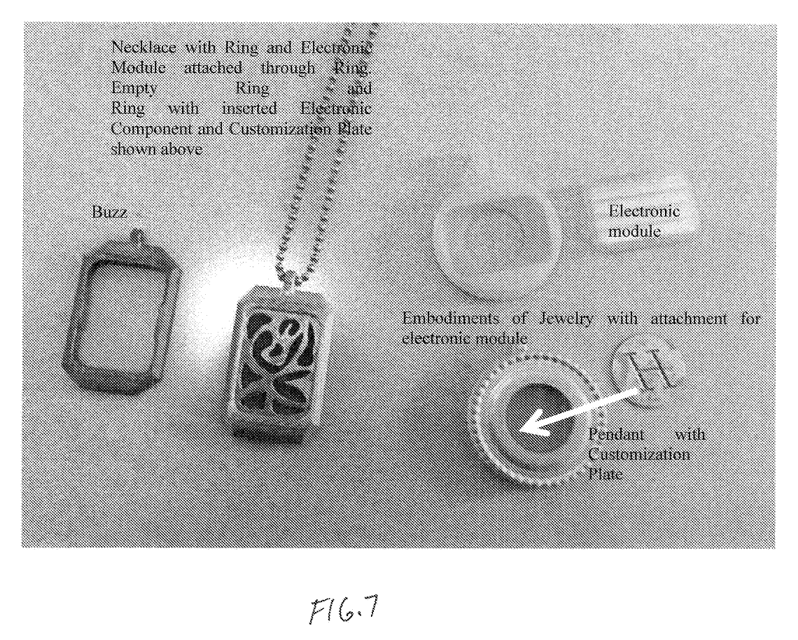

### DETAILED DESCRIPTION

In accordance with the various aspects of the invention, the computing devices of the invention may include a central processing unit, memory, input devices (e.g., keyboard and pointing devices), output devices (e.g., display devices), and storage devices (e.g., disk drives). The memory and storage devices are computer-readable media that may contain instructions. In addition, the data structures and message structures may be stored or transmitted via a data transmission medium, such as a signal on a communications link. Various communications links may be used, such as the Internet, a local area network, a wide area network, or a point-to-point dial-up connection.

The systems of the invention, in accordance with various aspects and embodiments, may use various computing systems or devices including personal computers, server computers, hand held or laptop devices, multiprocessor systems, microprocessor based systems, programmable consumer electronics, network PCs, minicomputers, mainframe computers, distributed computing environments that include any of the above systems or devices, and the like. The systems may also provide services to various computing systems such as personal computers, cell phones, personal digital assistants, consumer electronics, home automation devices, and so on.

The systems may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments. For example, the user interface component may be implemented on a server separate from the computer system that generates the information or data.

Unless defined otherwise, all technical and scientific terms used herein have the same meaning as commonly understood by one of ordinary skill in the art to which this invention belongs. Although any methods and materials similar or equivalent to those described herein can also be used in the invention, representative illustrative methods and materials are now described.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

In accordance with at least one aspect of the invention, high-end jewelry design is coupled with technology in a manner that is aesthetically appealing, providing tremendous flexibility to create bracelets, necklaces, IWPs, keychains, belts, and other jewelry and jewelry-like items. These designs incorporate powerful electronic capability within jewelry, which would be appropriate for sale in a jewelry store.

One object, in accordance with at least one aspect of the invention, is to provide a protection and communication system with interchangeable and customizable components that will overcome the shortcomings of know approaches.

Another object, in accordance with at least one aspect of the invention, is to provide a waterproof sealed electronic component including a board, a power source (such as a battery or a solar cell), a button, and a vibrator, which can be embedded in various forms of jewelry.

Another objective, in accordance with at least one aspect of the invention, is to enable the easy interchange of the sealed component among different types of jewelry, for example between a bracelet, a necklace, or a keychain. This is done through a variety of interchangeable connectors.

Another objective, in accordance with at least one aspect of the invention, is to enable the combination of jewelry and electronics (called IWP) to seamlessly integrate and provide the appearance of jewelry alone.

Another objective, in accordance with at least one aspect of the invention, is to enable the combination of jewelry and electronics to communicate with a mobile device, or directly with a network, using one or more communication protocols integrated into the IWP, including BLE.

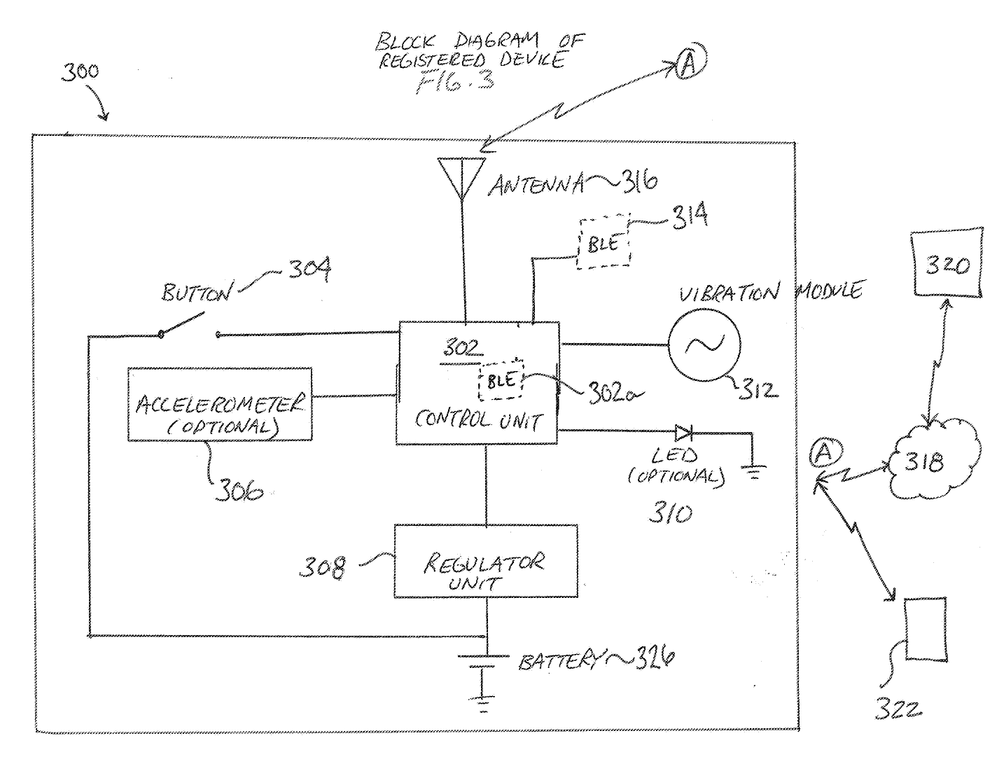

Another objective, in accordance with at least one aspect of the invention, is for the IWP to operate in multiple modes: either sending or receiving. In sending mode, one or more presses of a button (shown in FIG. 3) are transmitted to the mobile device or network. In receiving mode, these presses are translated to vibrations, each different from the other, on the IWPs or one or more recipients, or the recipient's mobile device.

Another objective, in accordance with at least one aspect of the invention, is for the IWP to be customizable via a set of interchangeable inserts that provide decorative customization.

Another objective, in accordance with at least one aspect of the invention, is to have software that resides on the mobile device, which receives messages from the IWP and transmits them to a cloud-based system. The software can also display personal information such as contact information and medical/insurance information, show geographic locations of various individuals, and provide alerting and SOS functions

Another objective, in accordance with at least one aspect of the invention, is to have cloud based software which manages all of the data related to the individuals registered in the network, track the individual via their IWPs, manage the communications between members of the Personal Network, maintain data integrity, and continue to transmit alerts even if the mobile device has been turned off or the IWP is not in standby-status with the mobile device.

Another objective, in accordance with at least one aspect of the invention, is to have a “Personal Social Network” of individuals who have been identified as those most important to communicate with, arranged in one or more groups that have attributes describing their familial as well as geographic proximity to certain individuals.

Another objective, in accordance with at least one aspect of the invention, is to have the electronic unit not require recharging, to be waterproof, and to be able to vibrate sufficiently as to be felt even when encased in a housing or jewelry.

Another objective, in accordance with at least one aspect of the invention, is to enable people to immediately alert individuals without having to touch their mobile device.

Another objective, in accordance with at least one aspect of the invention, is to be able to have a complete range of jewelry, such as bracelets, necklaces, etc., among which the electronic component can be integrated.

Referring now to FIG. 3, in accordance with the various aspects of the invention, an IWP is a device or registered device 300 as shown. The registered device 300 includes a control unit 302 and a battery 326. In accordance with one aspect of the invention, the control unit 302 includes a circuit board with BLE technology, such as a BLE module 302a. In accordance with another aspect of the invention, a BLE module 314 is a separate module from the control unit 302. The registered device 300 may include any one or more of the following, in communication with the control unit 302: a button or depressible unit 304, an accelerometer 306, a regulator unit 308, a Light Emitting Diode (LED) 310, a vibration module or unit 312. The registered device 300 also includes an antenna 316 in electrical communication with the control unit 302. The registered device 300 communicates with other devices, systems or computers using a communication protocol.

In accordance with at least one aspect of the invention, the registered device 300 uses the antenna 316 for communication using BLE protocol. In accordance with at least one other aspect of the invention, the registered device 300 can use any one or combination of communication units and protocol, independently or conjunction with BLE, including optical, Infrared (IR), laser optics, WiFi. Thus, the scope of the present disclosure is not limited by the type of communication protocol used and any known communication approach, including combinations thereof, may be utilized.

In accordance with at least one aspect of the invention, the registered device 300 can be incorporated into jewelry to create customizable intelligent jewelry. In accordance with at least one aspect of the invention, the registered device 300 communicates with software on a mobile device 322. In accordance with another aspect, the registered device 300 communicates through intermediate transmitter, such as through the internet 318, to a server, a host system, or a back-end data management service 320.

In accordance with at least one aspect of the invention, the registered device 300 can transmit information to a Personal Private Network (PPN) or Trusted Circle of device or people (TCD) equipped with either a mobile device or a mobile device in conjunction with a IWP, such as registered device 300. In accordance with the various aspects of this disclosure and the invention, the PPN or TCD may include any individual based on geographic location, relationship to the user of the registered device, or any other criteria selected by the user of the registered device 300 or the IWP. The registered device 300 can communicate with the TCD through various channels of communication as outlined herein and the scope of the present disclosure is not limited by the channel selected.

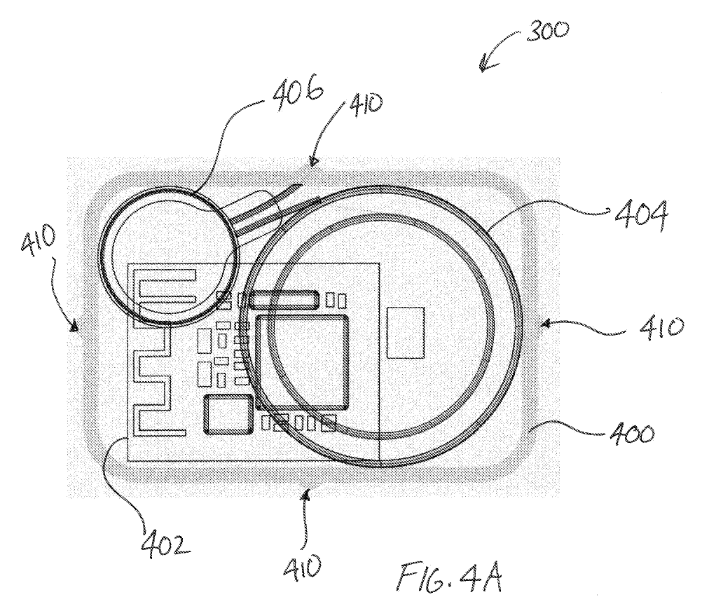

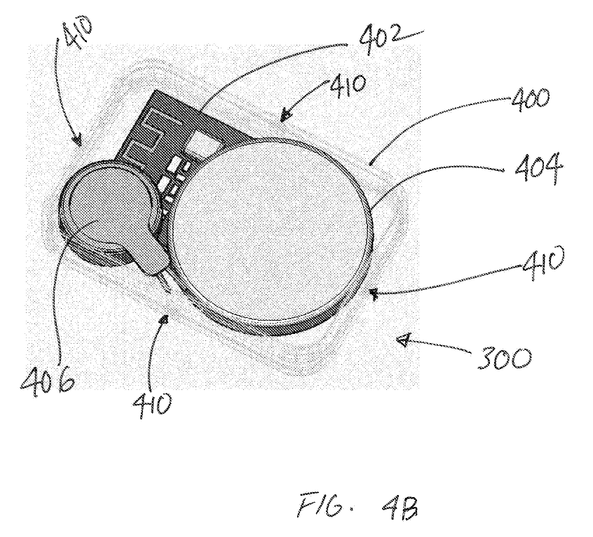

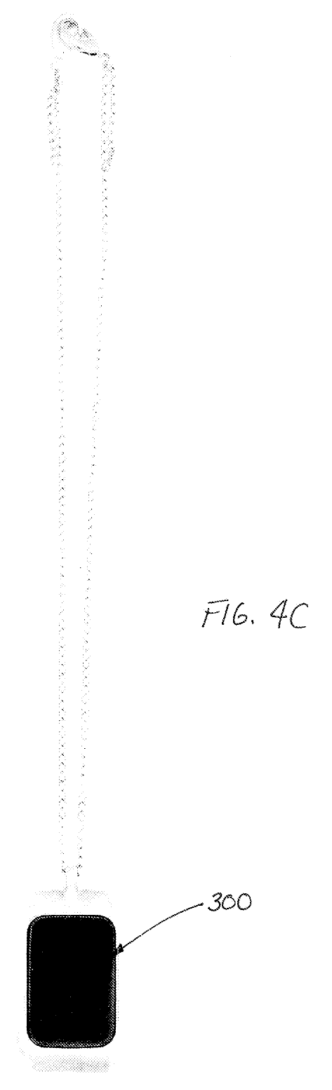

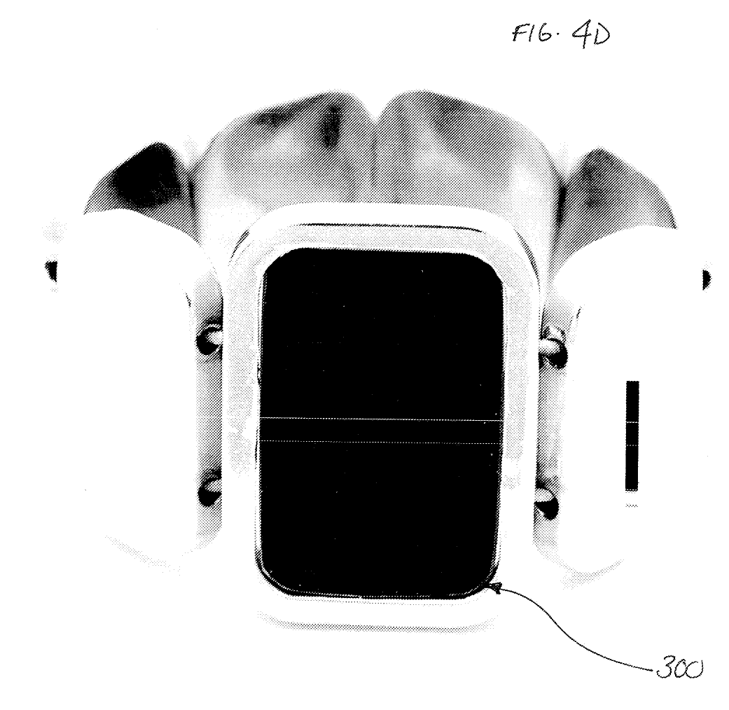

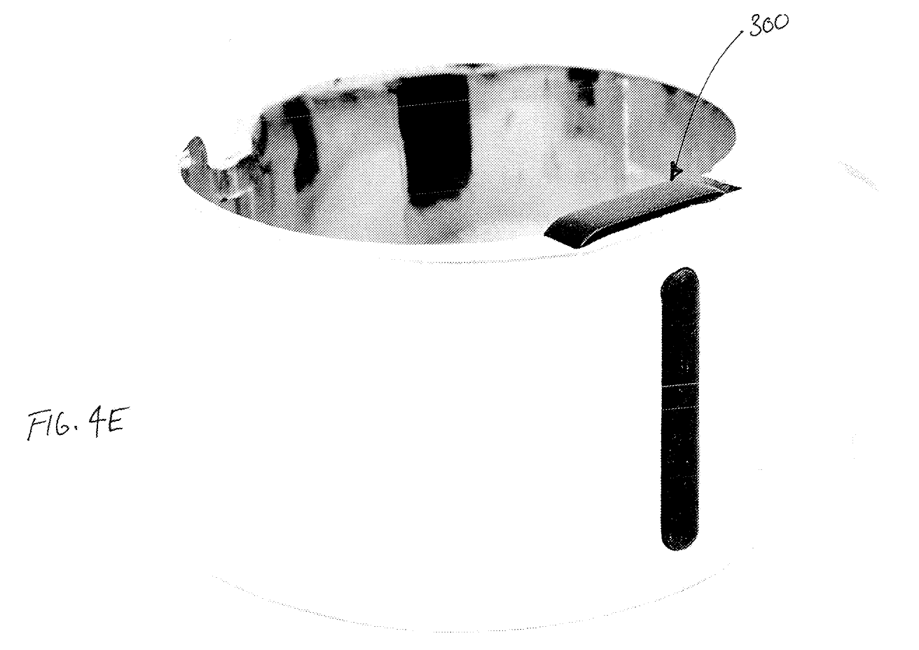

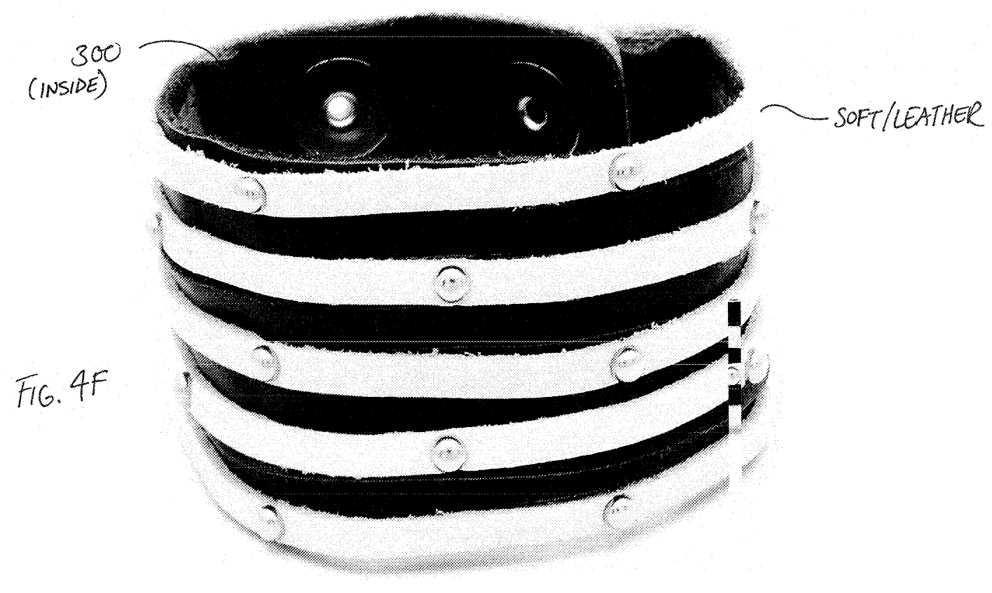

Referring to FIG. 3, FIG. 4A, and FIG. 4B, in accordance with various aspects of the invention, the IWP, such as the registered device 300, includes a waterproof enclosure 400 for housing electronic components 402, a battery 404, and a button 406 based on various design parameters. The IWP is coupled to the jewelry. In accordance with various aspects of the invention, there are multiple ways of attaching the IWP to the jewelry. One approach is an external ring (which may come in a number of shapes—rectangular, circular, oval, and square) into which the IWP can be inserted and removed. Another approach with be to couple the IWP directly to jewelry. In accordance with at least one aspect of the invention, bubbles or extensions 410 are incorporated to hold, via a press fitting, the IWP into the jewelry. These various aspects are disclosed as examples and other objects and advantages of the invention will become obvious to person of ordinary skill and it is intended that these objects and advantages are within the scope of the invention and the examples recited specifically are not intended to limit the scope of the claims.

The mobile device 322 and the system 320 includes software or program code that allows the user to perform any one or more of the following: account setup and sign-in; Personal Private Network or Trusted Circle setup; IWP or registered device connection to a mobile device; IWP and mobile device pairing; data entry; data gathering—location, audio, personal, other; historical & real time; data receiving—push notifications, communications displays; and alerts.

In accordance with various aspects of the invention, the software residing at a remote location or in the cloud includes, but is not limited to, a database and database schema, administrative panels including for the database administrator, business logic, the ability to create personal information and connections between individuals, and security or emergency services.

In accordance with various aspects of the invention, the IWP is designed to connect to and protect an individual with their TCD. The IWP and the system in communication with the IWP include features that allow controlled and specific communication with specific individual. Information is provided by the user, such as familial or personal closeness, in addition to geographic location. In accordance with various aspects of the invention, the information provided, is factored in the decision on which set of individuals in the TCD to alert in case of emergency and in what order. Because it is a cloud-based system, unlike a traditional 911 call or other phone-based system, once the alert has been passed to the cloud system, the cloud system will continue attempting to contact individuals according to proprietary algorithms which determine who to contact.

In accordance with various aspects of the invention, various messages, which can include emergency as well as non-emergency, are provide to and from the IWP. In accordance with one aspect of the invention, the IWP transmits two basic messages: Minor emergency and Major emergency. The actions to be followed upon that transmission are determined by proprietary algorithms in software associated with the mobile device or the back-end system. In accordance with other aspects of the invention, when the mobile device receives such a message from the IWP, the software is activated and gathers additional information such as current and historical geographic location. The information gathered can be sent from the mobile device to the system through cellular communication channels, the internet, or via any other communication channel.

In accordance with various aspects of the invention, the IWP receives two basic messages: Minor emergency and Major emergency, transmitted by the mobile device, which receives these messages from the back-end system. The mobile device also receives these messages. Upon receipt of this message, the mobile device, through the software stored therein, guides the recipient through a set of potential actions, provides additional information, and undertakes various additional processing actions.

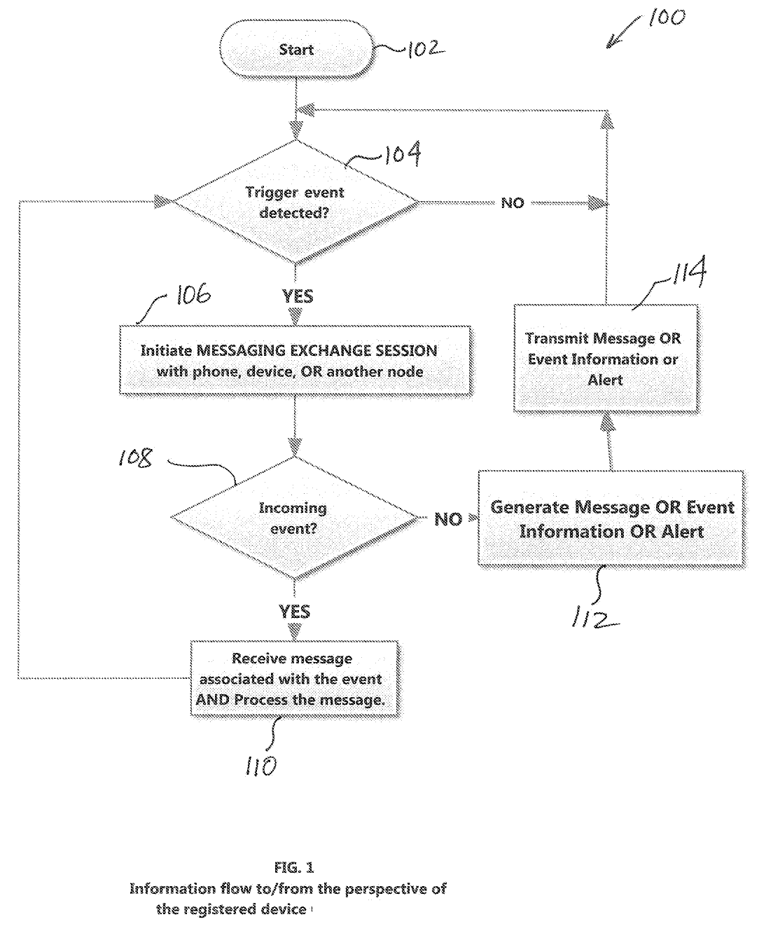

Referring now to FIG. 1, in accordance with various aspects of the invention, a flow process 100 is shown for communication to/from the IWP, such as the registered device 300 of FIG. 3. The process starts at step 102 and moves to step 104 to determine if a trigger event has been detected by the IWP. A trigger event is any event discussed herein, which causes the IWP to initiate communication. Examples of trigger events include pressing a button on the IWP, detection by the accelerometer of the IWP, or in coming communication from the mobile device. The examples listed are not exhaustive of all possible triggering events and the scope of the invention is not limited thereby. If a trigger event is NOT detected, the process returns to step 104 to await a trigger event and remains in sleep or low power consumption mode. If a trigger event is detected, then at step 106, the IWP changes to an active state (from a sleep or low-battery consumption mode) to initiate or start a message exchange session with the mobile device, the back-end system, or any nearby device. At step 108, the IWP determines if the trigger event is an incoming message. IF so, then at step 110 the message is received and processed, with any follow-up action needed. One the message is processed, the IWP return to low power mode or sleep mode the process returns to step 104 awaiting a new trigger event. If at step 108 the trigger event is not an incoming message or event, then the process moves to step 112. The IWP generates the message, which can be an event or information or an alert, and at step 114 transmits the information. If all transmissions associated with the outgoing information are complete, the IWP returns to step 104 and low power or sleep mode.

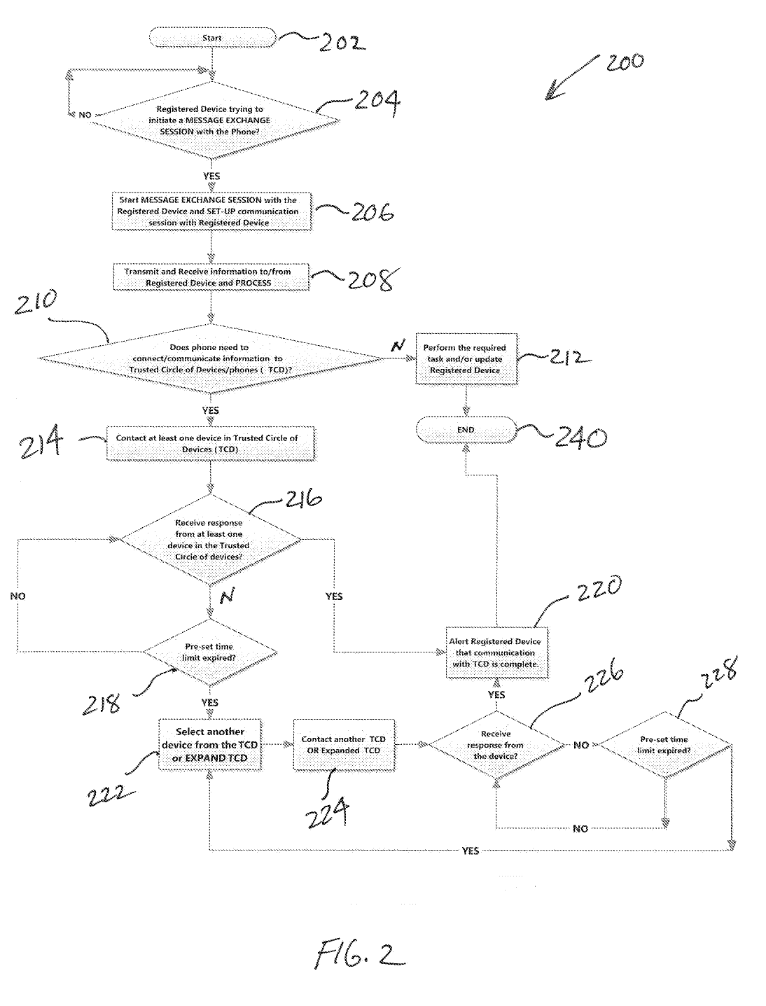

Referring now to FIG. 2, in accordance with various aspects of the invention, a flow process 200 is shown for communication to/from the mobile device linked to the IWP. The process starts at step 202 and at step 204 the mobile device determines if there is a need to initiate a message exchange session (MES), either because the IWP is trying to send information to the mobile device or vise-versa. If a session is not initiated, then the process returns to step 202. If a MES is needed, then the process moves to step 206 to start the MES session with the IWP. The process moves to step 208 where the information is transmitted or received and processed. At step 210, the mobile device, with the software therein, determines if processing of the information resulted in a situation that requires contacting a person in the PPN or the TCD. If not, then the process moves to step 212 and performs the required task or action and, if needed, updates the IWP and the MES ends at step 240. If as step 210, the mobile device has to contact a person in the TCD (or the PPN), then the process moves to step 214 and a message or information is sent to at least one person in the TCD.

At step 216, the process, which is running on the mobile device, determines if a response is received from at least one person in the TCD. If not, the process waits at step 218 until a pre-determined time limit expires and then moves to step 222 to select another person from the list of TCD and the alternative person or persons from the list of TCD or PPN are contacted at step 224. If a response is received at step 216 from a person in the TCD, then the process moves to step 220 to alert the IWP that a message has been communicated to at least one person in the TCD and the information received during the MES is sent to at least one person in the TCD.

If contact is initiated with alternative persons at step 224, the process moves to steps 226 and 228 and as noted above awaits confirmation that some in the TCD has been reached. This continues until at least one person in the TCD is reached or attempts have been made to reach all individuals or person in the TCD/PPN. IF no individual was reached, then the mobile device can attempt to contact parties outside the TCD depending on the parameters defined by the use of the IWP and information stored about the use in the back-end system.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims. As will be apparent to those of skill in the art upon reading this disclosure, each of the individual embodiments described and illustrated herein has discrete components and features which may be readily separated from or combined with the features of any of the other several embodiments without departing from the scope or spirit of the invention. Any recited method can be carried out in the order of events recited or in any other order which is logically possible.

In accordance with the teaching of the invention and certain embodiments, a program or code may be noted as running on a computing device. A computing device is an article of manufacture. Examples of an article of manufacture include: a server, a mainframe computer, a mobile device, mobile telephone, a multimedia-enabled smartphone, a tablet computer, a personal digital assistant, a personal computer, a laptop, a set-top box, an MP3 player, an email enabled device, a web enabled device, or other special purpose computer each having one or more processors (e.g., a Central Processing Unit, a Graphical Processing Unit, or a microprocessor) that is configured to execute a computer readable program code (e.g., an algorithm, hardware, firmware, and/or software) to receive data, transmit data, store data, or perform methods. The article of manufacture (e.g., computing device) includes a non-transitory computer readable medium having a series of instructions, such as computer readable program steps encoded therein. In certain embodiments, the non-transitory computer readable medium includes one or more data repositories.

By way of illustration and not limitation, the computing device can include: an input/output means, such as a keyboard, a mouse, a stylus, touch screen, a camera, a scanner, or a printer; a processor; a non-transitory computer readable medium including at least one instruction/task or a series of instructions, such as computer readable program with steps encoded therein.

The non-transitory computer readable medium includes corresponding computer readable program code and may include one or more data repositories. The processors access the computer readable program code encoded on the corresponding non-transitory computer readable mediums and execute one or more corresponding instructions. Other hardware and software components and structures are also contemplated.

In accordance with various aspects of the invention and in certain embodiments, a data repository is referenced. The data repositories comprises one or more hard disk drives, tape cartridge libraries, optical disks, combinations thereof, and/or any suitable data storage medium, storing one or more databases, or the components thereof, in a single location or in multiple locations, or as an array such as a Direct Access Storage Device (DASD), redundant array of independent disks (RAID), virtualization device, etc.

In accordance with various aspects of the invention and in certain embodiments, the data repository is structured by a database model, such as a relational model, a hierarchical model, a network model, an entity-relationship model, an object-oriented model, a combination thereof, or the like. For example, in certain embodiments, the data repository is structured in a relational model that stores data regarding a computer-aided design.

In accordance with various aspects of the invention and in certain embodiments and in accordance with any aspect of the invention, computer readable program code is encoded in a non-transitory computer readable medium of the computing device. The processor, in turn, executes the computer readable program code to create or amend an existing computer-aided design using a tool. In other embodiments, the creation or amendment of the computer-aided design is implemented as a web-based software application in which portions of the data related to the computer-aided design or the tool or the computer readable program code are received or transmitted to a computing device of a host.

In certain embodiments based on the various aspects of the invention, reference is made to communication between two electronic devices or components. The communication fabric may include any means for communication and, includes, for example: wired communication on a local bus, communication throughout a computer device, the Internet, an intranet, an extranet, a storage area network (SAN), a wide area network (WAN), a local area network (LAN), a virtual private network, a satellite communications network an interactive television network, any combination of the foregoing, and the like. In certain embodiments, the communication fabric contains either or both wired or wireless connections for the transmission of signals including electrical connections, magnetic connections, or a combination thereof. Examples of these types of connections include: radio frequency connections, optical connections, telephone links, a Digital Subscriber Line, or a cable link. Moreover, communication fabric utilize any of a variety of communication protocols, such as Transmission Control Protocol/Internet Protocol (TCP/IP), for example. In certain embodiments, the communication fabric includes one or more switches.

In accordance with various aspects of the invention and in certain embodiments, the processor accesses corresponding Application Program Interfaces (APIs) encoded on the corresponding non-transitory computer readable medium and execute instructions to electronically communicate with computing device during a computer-aided session, for example. Similarly, the processor accesses the computer readable program code, encoded on the non-transitory computer readable medium, and executes an instruction to electronically communicate with the computing device via the respective communication fabric. In certain embodiments, the computing device 110 provides access to the computing devices to execute the computer readable program code via Software as a Service (SaaS).

In accordance with various aspects of the invention and in certain embodiments, the system includes a hardware-based module (e.g., a digital signal processor (DSP), a field programmable gate array (FPGA)) and/or a software-based module (e.g., a module of computer code, a set of processor-readable instructions that are executed at a processor). In some embodiments, one or more of the functions associated with the system is performed, for example, by different modules and/or combined into one or more modules locally executable on one or more computing devices.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the invention. Any recited method can be carried out in the order of events recited or in any other order which is logically possible.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof.

Additionally, it is intended that such equivalents include both currently known equivalents and equivalents developed in the future, i.e., any elements developed that perform the same function, regardless of structure. The scope of the invention, therefore, is not intended to be limited to the exemplary embodiments shown and described herein. Rather, the scope and spirit of invention is embodied by the description herein and the Appendix and related to the claim.

What is claimed is:

1. An intelligent wearable device comprising:
a housing; and
and event indication module secured within the housing.

2. The device of claim 1, wherein the event indication module comprises:
a power source;
a control module electrically connected to the power source;
a low energy communication module electrically connected to the power source and controlled by the control module;
an antenna electrically connected to the communication module; and
a button electrically connected to the power source and in communication with the control module,
wherein the button is used to initiate an event and causes the control module to send a signal to the communication module and the communication module transmits the signal to an external device.

3. The device of claim 2, wherein the power source is a battery.

4. The device of claim 2, wherein the power source is a solar cell.

5. The device of claim 1, wherein the housing is integrated, at least in part, into jewelry.

6. The device of claim 1, wherein the housing is integrated, at least in part, into clothing.

7. The device of claim 1, wherein the housing includes a water-resistant membrane.

8. The device of claim 1, wherein the low energy communication module uses at least one protocol selected from the group of protocols including BLE protocol and RF protocol.

9. A system comprising:
an integrated wearable apparatus; and
a device in communication with the wearable apparatus using a wireless communication protocol.

10. The system of claim 9, wherein the integrated wearable apparatus comprises:
a power source;
a communication control module electrically connected to the power source, wherein the communication control module includes a low energy communication unit for communicating with the device; and
an event detection module in communication with the communication control module, wherein the event detection module is used to initiate an event and causes the communication control module to send a signal to the device.

11. The system of claim 10, wherein the power source is at least one type of power source selected from a group of power source types that includes a battery, a rechargeable battery, and a solar cell.

12. The system of claim 10, wherein the integrated wearable apparatus includes a housing that is integrated into jewelry.

13. The system of claim 10, wherein the low energy communication unit uses at least one protocol selected from the group of protocols including BLE protocol and RF protocol.

14. The system of claim 10, wherein the event detection module includes at least one trigger selected from a group including: an incoming signal from the device, an accelerometer and a button.

15. A method for communication to/from a wearable apparatus, the method comprising:
determining if a trigger event has been detected by the wearable apparatus;
activating, if the trigger event is detected, the wearable apparatus from low power mode to active mode;
initiating communication between the wearable apparatus and a device based on detection of the trigger event; and
exchanging at least one message between the wearable apparatus and the device.

16. The method of claim 15, further comprising:
determining if the trigger event is an incoming message initiated from the device;
processing the incoming message; and
returning the wearable apparatus to low power mode until a new trigger event is detected.

17. The method of claim 15, further comprising:
determining if the trigger event is initiated by the wearable apparatus that requires an outbound message;
generating, if the trigger event requires the outbound message, the outbound message;
transmitting the outbound message to the device;
taking follow-up action if an incoming message is received, in response to the outbound message, from the device; and
returning the wearable apparatus to low power mode until a new trigger event is detected.
